(19) United States
(12) Patent Application Publication
(10) Pub. No.: US 2016/0170709 A1
(43) Pub. Date: Jun. 16, 2016

(54) DEVICE AND METHOD FOR CONTROLLING SOUND OUTPUT

(71) Applicant: SAMSUNG ELECTRONICS CO., LTD., Suwon-si (KR)

(72) Inventors: Ju-yun JANG, Hwaseong-si (KR); Yang-sun RYU, Seongnam-si (KR); Cheul-hee HAHM, Seongnam-si (KR)

(73) Assignee: SAMSUNG ELECTRONICS CO., LTD., Suwon-si (KR)

(21) Appl. No.: 14/941,758

(22) Filed: Nov. 16, 2015

(30) Foreign Application Priority Data
Dec. 12, 2014 (KR) 10-2014-0179356

(51) Int. Cl. G06F 3/16; G06F 3/0484; G06F 3/0482

(52) U.S. Cl. CPC G06F 3/167; G06F 3/0482; G06F 3/04842

(57) ABSTRACT

A device and method for controlling sound output. The device includes a sound outputter configured to output sound of content; a display configured to display a plurality of windows; and a controller configured to, in response to receiving a user input signal indicating a selection of one of the plurality of windows, output sound of content being reproduced in the selected window through the sound outputter and discontinue outputting sound of content being reproduced in the plurality of windows, except for the selected window.

### CROSS-REFERENCE TO RELATED APPLICATION

This application claims the benefit of priority from Korean Patent Application No. 10-2014-0179356, filed on Dec. 12, 2014, in the Korean Intellectual Property Office, the disclosure of which is incorporated herein by reference in its entirety.

### BACKGROUND

1. Field

Methods and apparatuses consistent with exemplary embodiments relate to devices and methods for controlling sound output, and more particularly, to devices and methods for controlling sound output and subtitle output of a plurality of pieces of content when reproducing the plurality of pieces of content in a plurality of windows.

2. Description of Related Art

As various terminals such as personal computers, laptop computers, smart TVs, cellular phones, etc. become multifunctional and provide various functionalities, there is a trend to providing a multi-window function. The multi-window function means a function of splitting a screen into a plurality of areas and independently displaying a plurality of pieces of content or application programs simultaneously.

There is a recent need for research into a method in which a terminal providing the multi-window function provides a user with a more convenient environment for viewing a number of pieces of content.

### SUMMARY

Provided are devices and methods for controlling sound output and subtitle output of a plurality of pieces of content when reproducing the plurality of pieces of content on a plurality of windows.

Additional aspects will be set forth in part in the description which follows and, in part, will be apparent from the description, or may be learned by practice of exemplary embodiments.

Exemplary embodiments may address at least the above problems and/or disadvantages and other disadvantages not described above. Also, exemplary embodiments are not required to overcome the disadvantages described above, and an exemplary embodiment may not overcome any of the problems described above.

According to an aspect of an exemplary embodiment, a device includes: a sound outputter configured to output sound of content; a display configured to display a plurality of windows; and a controller configured to, in response to receiving a selection of one of the plurality of windows, output the sound of the content being reproduced in the selected window through the sound outputter.

In response to the receiving the selection of the one of the plurality of windows, the controller is further configured to discontinue outputting sound of contents being reproduced in the plurality of windows, except for the sound of the contents in the selected window. Based on the receiving the selection, the controller is configured to control the display to display subtitles of the content being reproduced in the plurality of windows, except for the selected window.

The controller may display subtitles of the content being reproduced in the selected window, on a determined portion of an entire area of the display, based on user input.

The controller may display subtitles of the content being reproduced in the selected window such that the displayed subtitles do not overlap with an image of the content being reproduced in the selected window, based on user input.

The controller may enlarge the selected window in response to receiving user input, and display the enlarged, selected window.

The controller may rearrange the windows among the plurality of windows, except for the selected window, in response to receiving user input.

The controller may discontinue outputting the sound of the content being reproduced in the selected window and instead, output sound of content being reproduced in another window in response to receiving user input selecting the other window, where the other window is different from the selected window.

The controller may set a first window of the plurality of windows as a sub-window, may set a second window of the plurality of windows that is different from the first window, as a main window, and display the sub-window inside the main window such that the sub-window overlaps the main window.

The controller may display subtitles of content being reproduced in the sub-window on a determined portion of an entire area of the display in response to receiving user input selecting the sub-window.

According to an aspect of another exemplary embodiment, a method includes: displaying a plurality of windows on a display; receiving a user input signal that selects one of the plurality of windows; outputting, through a sound outputter, sound of content being reproduced in the selected window.

The method may further include: discontinue outputting sound of content being reproduced in the plurality of windows, except for the selected window, displaying subtitles of the content being reproduced in the plurality of windows, except for the selected window, on areas of the display corresponding to the plurality of windows, based on user input.

The method may further include: displaying subtitles of the content being reproduced in the selected window, on a determined portion of an entire area of the display, based on user input.

The method may further include: displaying subtitles of the content being reproduced in the selected window such that the displayed subtitles do not overlap with an image of the content being reproduced in the selected window, based on user input.

The method may further include: enlarging the selected window in response to receiving user input and displaying the enlarged selected window.

The enlarging and displaying of the selected window may include rearranging the windows among the plurality of windows, except for the selected window, in response to receiving user input.

The method may further include: discontinuing outputting the sound of the content being reproduced in the selected window and outputting the sound of content being reproduced in another window in response to receiving user input selecting the other window, where the other window is different from the selected window.

The displaying of the plurality of windows may include: setting a first window of the plurality of windows as a sub-window, setting a second window of the plurality of windows different from the first window as a main window, and displaying the sub-window inside the main window such that the two overlap.

The method may further include: displaying subtitles of content being reproduced in the sub-window on a determined portion of an entire area of the display in response to receiving user input selecting the sub-window.

### BRIEF DESCRIPTION OF THE DRAWINGS

These and/or other aspects will become apparent and more readily appreciated from the following description of the exemplary embodiments, taken in conjunction with the accompanying drawings, in which:

FIG. 1 is a flow diagram illustrating displaying contents according to an exemplary embodiment;

FIG. 2 is a flowchart illustrating a method of displaying contents according to an exemplary embodiment;

FIG. 3 is a flowchart illustrating a method of displaying subtitles of content that are being reproduced in a plurality of windows according to an exemplary embodiment;

FIG. 4 is a flowchart illustrating a method of displaying subtitles of content that are being reproduced in a window selected by a user according to an exemplary embodiment;

FIG. 5 is a view illustrating displaying subtitle of content that is being reproduced in a window selected by a user according to an exemplary embodiment;

FIG. 6 is a flowchart illustrating a method of enlarging and displaying a window selected by a user according to an exemplary embodiment;

FIG. 7 is a view illustrating a method of enlarging and displaying a window selected by a user according to an exemplary embodiment;

FIG. 8 is a view illustrating another example of displaying subtitle of content that is being reproduced in a selected window according to an exemplary embodiment;

FIGS. 9A and 9B are views illustrating another example of enlarging and displaying a selected window according to an exemplary embodiment;

FIG. 10 is a view illustrating displaying a main window and a sub-window according to an exemplary embodiment;

FIG. 11 is a flow diagram illustrating changing a number of a plurality of windows according to an exemplary embodiment; and

FIGS. 12 and 13 are block diagrams illustrating a device according to exemplary embodiments.

### DETAILED DESCRIPTION OF EXEMPLARY EMBODIMENTS

Reference will now be made in detail to exemplary embodiments, examples of which are illustrated in the accompanying drawings. In this regard, the exemplary embodiments may have different forms and should not be construed as being limited to the descriptions set forth herein. Accordingly, exemplary embodiments are merely described below, by referring to the figures. Throughout the specification, analogous numeric references refer to analogous elements. As used herein, the term “and/or” includes any and all combinations of one or more of the associated listed items. Expressions such as “at least one of,” when preceding a list of elements, modify the entire list of elements and do not modify the individual elements of the list.

In the following description, well-known functions or constructions are not described in detail since they would obscure exemplary embodiments with unnecessary detail. Also, while terms “first” and “second” are used to describe various components, it is obvious that the components are not limited to the terms “first” and “second”. The terms “first” and “second” are used only to distinguish between each component.

Hereinafter, a device related to one or more exemplary embodiments is described in detail with reference to the drawings.

Throughout the description of exemplary embodiments, a device may include a fixed terminal such as a digital television (TV), a desktop computer, etc. The device may also include a cellular phone, a smartphone, a tablet personal computer (PC), a laptop computer, a digital broadcasting terminal, a personal digital assistant (PDA), a portable multimedia player (PMP), a navigation device, and etc.

Throughout exemplary embodiments, it will also be understood that when an element is referred to as being “connected to” or “coupled with” another element, it can be directly connected to or coupled with the other element, or it can be electrically connected to or coupled with the other element by having an intervening element interposed therebetween. Also, when a part “includes” or “comprises” an element, unless there is a particular description contrary thereto, the part can further include other elements, not excluding the other elements.

Hereinafter, terms used in exemplary embodiments are briefly described.

Throughout exemplary embodiments, ‘content’ may mean a predetermined moving image. The moving image may be a broadcasting stream that is input through a TV tuner, a moving image file stored in a device, a moving image file that is receivable from an external storage medium but is not limited thereto. In an exemplary embodiment, content may also mean a still image provided with an audio feed or a combination of still images e.g., such as a presentation, provided with recorded audio feed.

The content may include subtitle information of corresponding content. The subtitle information may include information regarding text generated by converting sound information of the corresponding content into text.

The subtitle information may be displayed by being added to an image of content. That is, the subtitle information may be displayed to overlap with the image of the content or may be displayed on a specific area so as not to overlap with the image. Hereinafter, one or more exemplary embodiments will be described in detail with reference to the attached drawings.

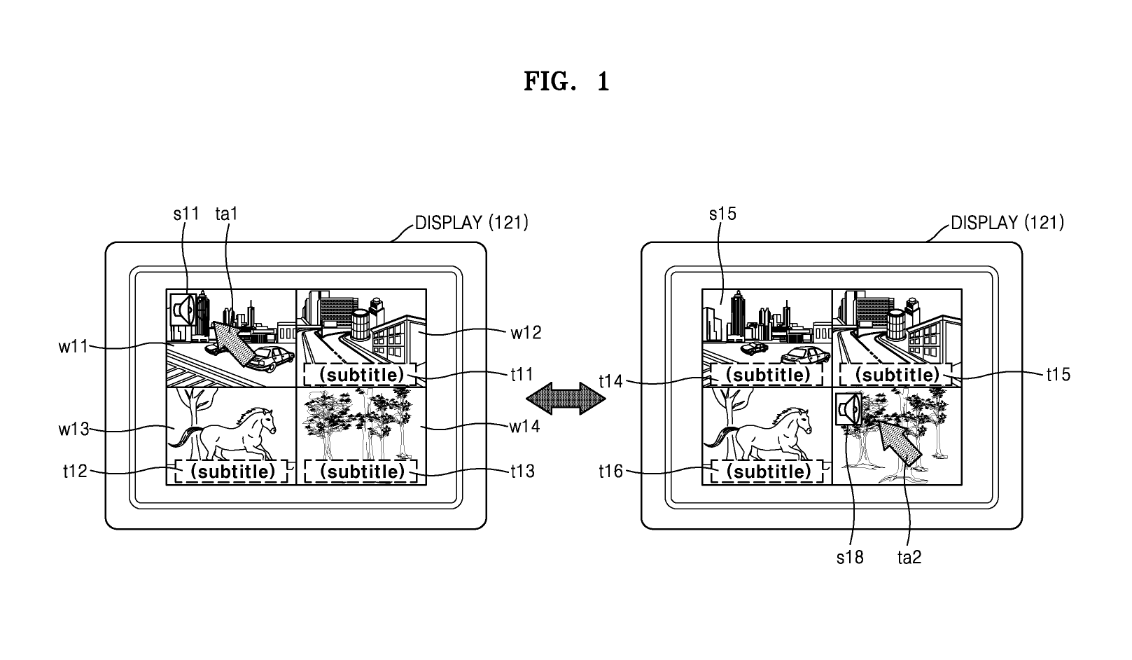

FIG. 1 is a flow diagram illustrating displaying an image according to an exemplary embodiment.

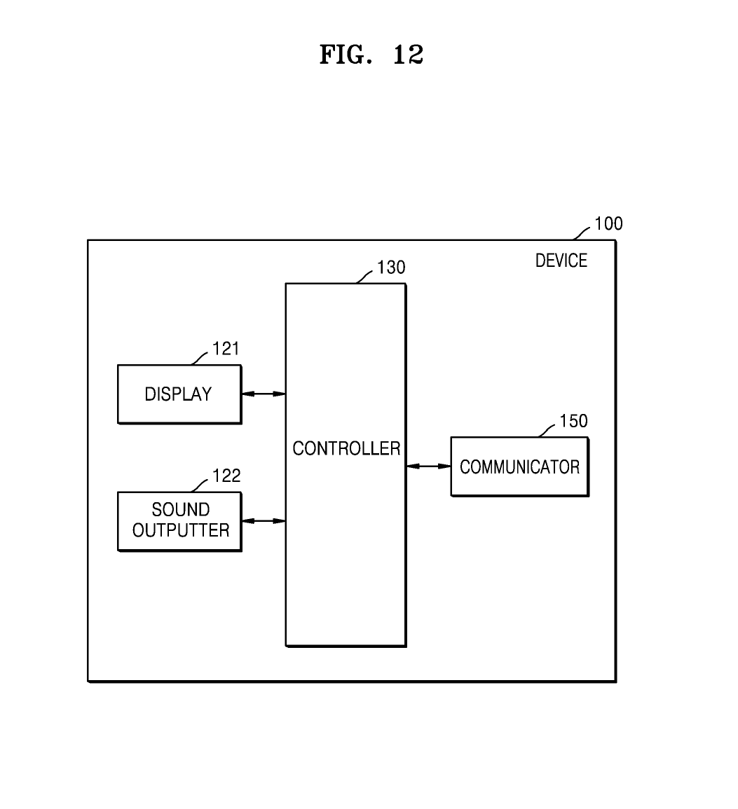

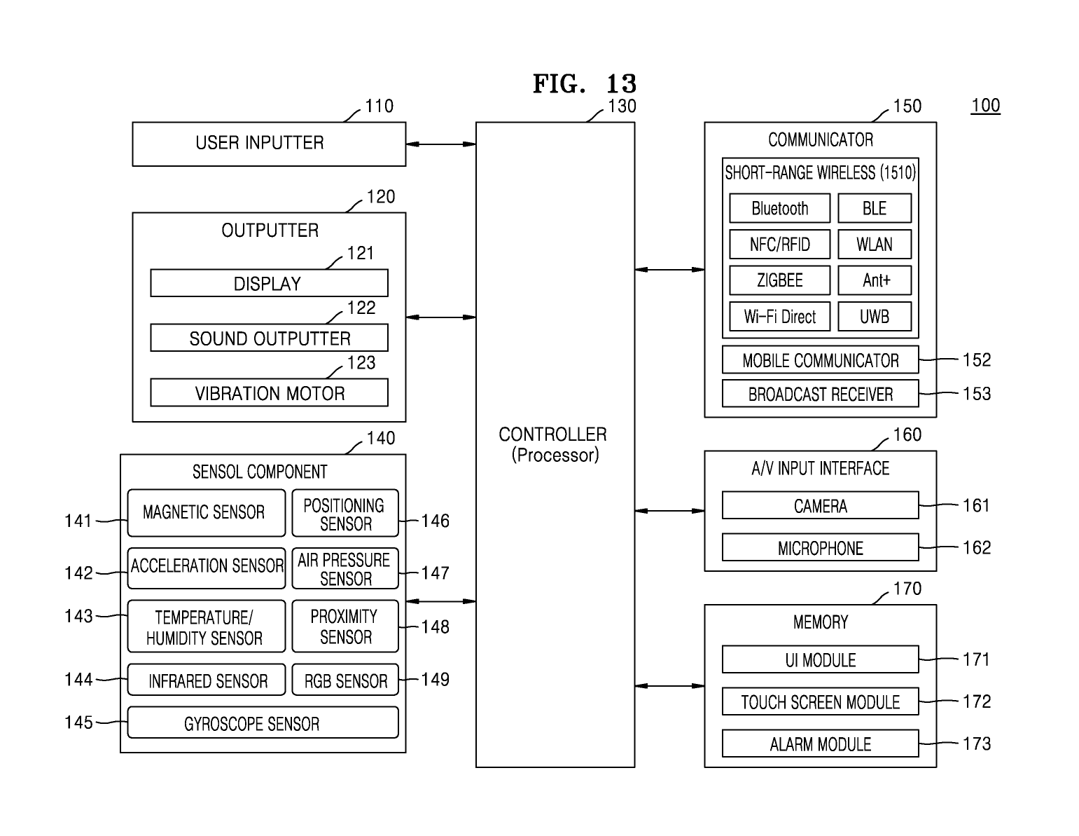

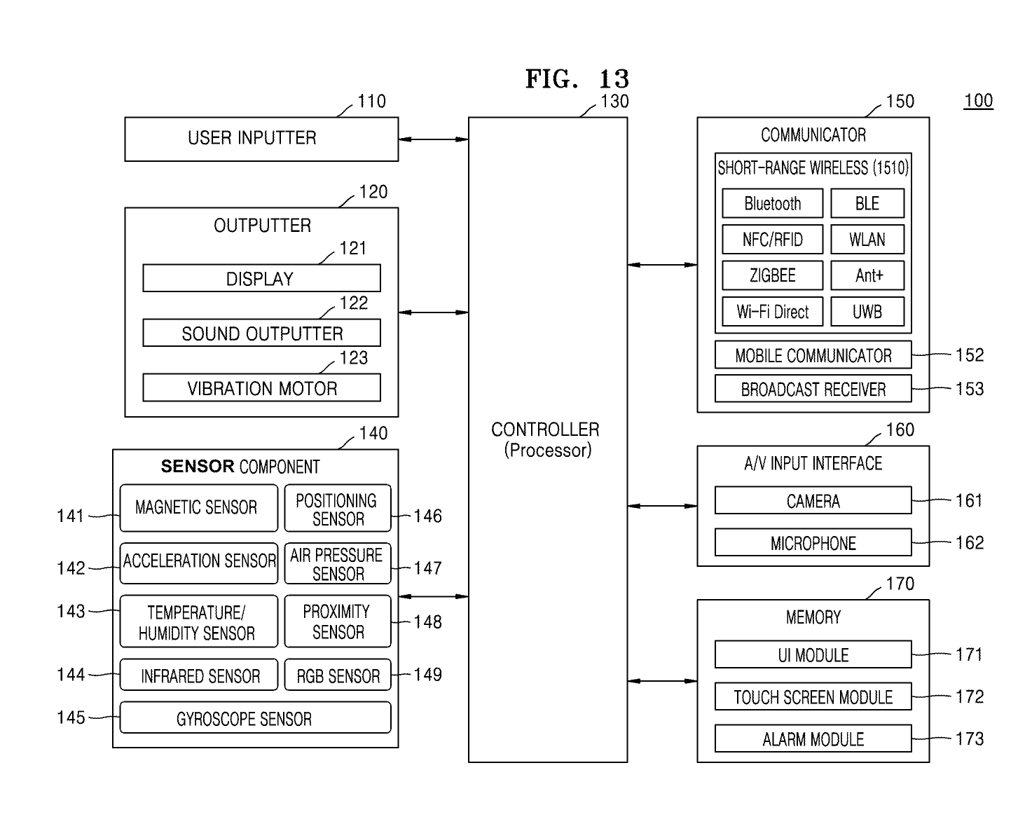

A display 121 of a device such as the ones shown in FIGS. 12 and 13 and discussed in greater detail below, may provide a multi-window function or functionality, according to an exemplary embodiment.

The multi-window function or functionality means a function of splitting a screen into a plurality of areas and independently displaying a plurality of pieces of content or application programs simultaneously in various areas of the screen.

According to an exemplary embodiment, the device may reproduce the plurality of pieces of content on a plurality of respective windows configuring a multi-window. The device may output sound of one of the plurality of pieces of content that are being reproduced according to a user selection and may stop outputting sound of the content that is being reproduced on other windows. Thus, sound information of one piece of content may be more accurately provided to a user.

The device may display subtitle information of the content, other than the content of which sound information is being output, on the display 121, thereby providing the user with information regarding corresponding content.

That is, according to an exemplary embodiment, the user may obtain the sound information of the one content according to the user selection and may simultaneously obtain the subtitle information of the other content while watching a plurality of images using the multi-window function or functionality, and thus information regarding the plurality of pieces of content may be more accurately and conveniently provided to the user. In FIG. 1, a view on the left illustrates an example of selecting a first window w11 when predetermined content is being reproduced on each of a plurality of windows w11, w12, w13, and w14. The device may output sound information of content that is being reproduced in the first window w11 through a sound outputter such as the sound outputter 122 shown in FIG. 12. An icon ta1 in the form of an arrow shown in the first window w11 is used to indicate that the first window w11 is selected for sound output and the form thereof is not limited thereto but is provided by way of an example. That is, in an exemplary embodiment, an icon or other elements such as a border around the selected window, highlighting the selected window, and so on may be used to show the user selection and/or to show the window for which the sound is being output.

A first icon s11 displayed on the first window w11 is an icon indicating that the sound information of the content that is being reproduced in the first window w11 is being output. A form of the icon indicating the sound information is being output is not limited thereto but provided by way of an example only and may not be displayed. When the first window w11 is selected, the device 100 may stop outputting sound of the content that is being reproduced in each of the windows w12, w13, and w14.

When the first window w11 is selected, the device such as the device 100 shown in FIG. 12, may display subtitle information of the content that is being reproduced in the windows w12, w13, and w14, other than the first window w11, in areas t11, t12, and t13 respectively corresponding to the windows w12, w13, and w14 on the display, such as the display 121 shown in FIG. 12. In FIG. 1, the view on the right illustrates an example of selecting the fourth window w14 when predetermined content is being reproduced in each of the plurality of windows w11, w12, w13, and w14, according to an exemplary embodiment.

If the device receives input to select the fourth window w14 when outputting the sound information of the content that is being reproduced in the first window w11, the device may stop outputting the sound of the content that is being reproduced in the first window w11 and may output sound information of content that is being reproduced in the fourth window w14 through the sound outputter, such as the sound outputter 122 shown in FIG. 12. The device may also display subtitle information of the content that is being reproduced in the first window w11 in a partial area t14 of the first window w11. That is, the device may provide content information via the subtitle information after stopping the output of the sound of the content that is being reproduced in the first window w11.

An icon ta2 in the form of the arrow shown in the fourth window w14 is used to indicate that the fourth window w14 is selected as a window for which the sound is to be output. An icon s18 displayed in the fourth window w14 is used to indicate that the sound of the content that is being reproduced in the fourth window w14 is being output.

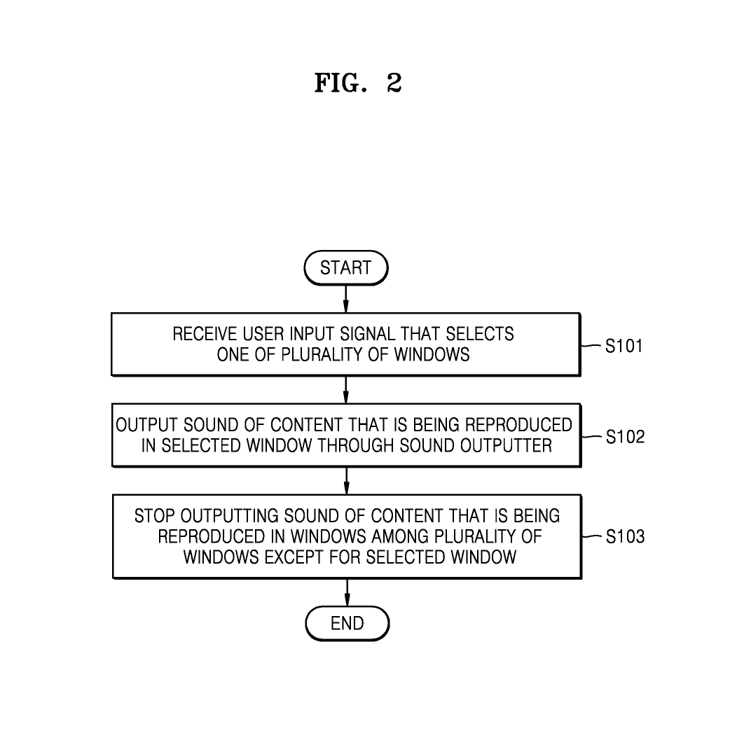

FIG. 2 is a flowchart illustrating a method of displaying content according to an exemplary embodiment.

In operation S101, a controller 130 of the device 100 (shown in FIG. 12) may receive a user input signal that selects one of a plurality of windows through a user inputter 110. A user may select a window in which content is display and sound of which is to be output, from among a plurality of pieces of content that are being reproduced in the plurality of windows.

For example, the user input signal may be a signal having a remote controller that transmits a control signal to a TV as an inputter or a signal having a mouse, a keyboard, etc. that transfers the control signal to a computer as the inputter provided by way of an example but is not limited thereto. For example, the user input signal may be a user touch input on a touch screen. In operation S102, the controller 130 of the device 100 (shown in FIG. 12) may output the sound of the content that is being reproduced in the selected window through the sound outputter 122, according to an exemplary embodiment.

In operation S103, the controller 130 of the device 100 may discontinue outputting sound of content being reproduced in the plurality of windows, except for the selected window.

That is, the device 100 may output sound only of the content that is being reproduced in a single window selected by a user and stop outputting sound of other windows, thereby more accurately providing the user with sound information of a single piece of content.

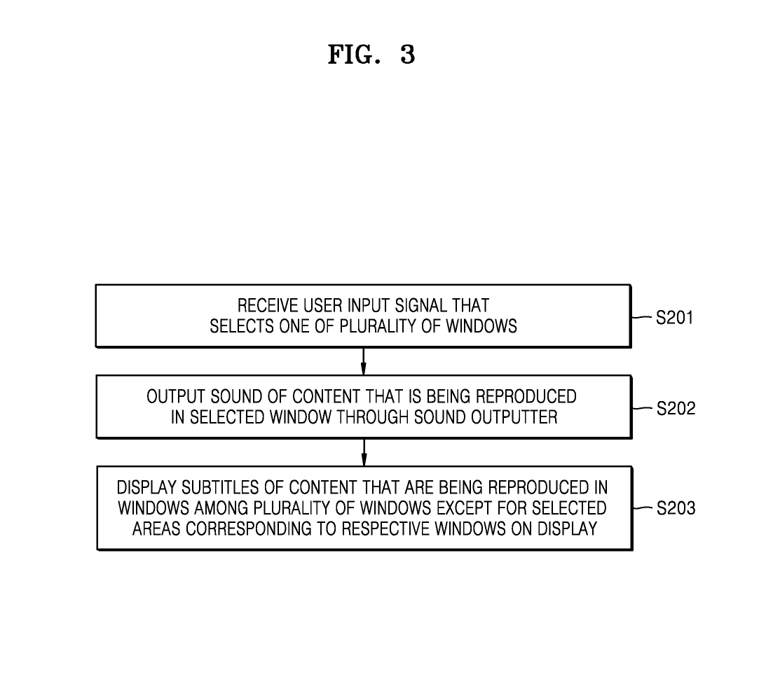

FIG. 3 is a flowchart illustrating a method of displaying subtitles of content that are being reproduced in a plurality of windows according to an exemplary embodiment.

In operation S201, the controller 130 of the device 100 may receive a user input signal that selects one of the plurality of windows through the user inputter 110.

In operation S202, the controller 130 of the device 100 may output sound of content that is being reproduced in the selected window through the sound outputter 122.

In operation S203, the controller 130 of the device 100 may display the subtitles of the content that are being reproduced in the windows among the plurality of windows except for the selected window in areas corresponding to the respective windows in the display 121.

The device 100 according to an exemplary embodiment may display subtitle information including text generated by converting sound information with respect to content being reproduced, in windows other than a window for which sound is being output, thereby providing a user with content information.

The controller 130 of the device 100 may preset an area in which the subtitle information of the content is to be displayed, for each window. The device 100 may display a graphic user interface, such as a predetermined icon, in a corresponding location of the display 121, and the graphic user interface may indicate a location in which the subtitle information is to be displayed for each window.

The subtitle information may be displayed in a partial area of a corresponding window, whereas the subtitle information may be displayed in an external area of a corresponding window that does not overlap with content that is being reproduced in the corresponding window.

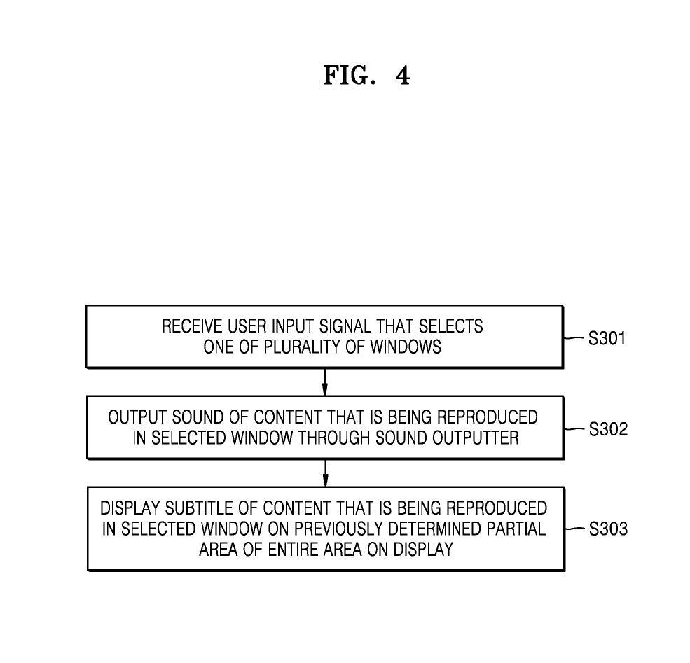

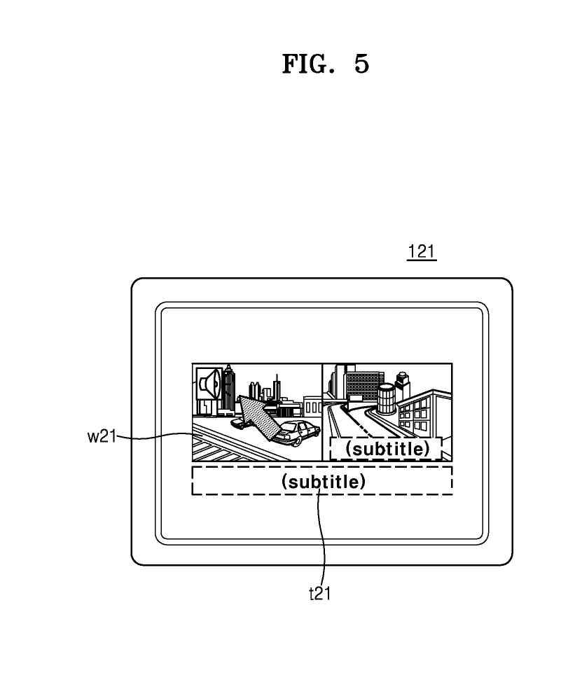

FIG. 4 is a flowchart illustrating displaying subtitle of content that is being reproduced in a window selected by a user according to an exemplary embodiment. FIG. 5 is a view illustrating displaying subtitle of content that is being reproduced in a window selected by a user according to an exemplary embodiment.

In operation S301 of FIG. 4, the controller 130 of the device 100 may receive a user input signal that selects one of a plurality of windows through the user inputter 110.

In operation S302, the controller 130 of the device 100 may output sound of the content that is being reproduced in the selected window through the sound outputter 122.

In operation S303, the controller 130 of the device 100 may display the subtitle of the content that is being reproduced in the selected window on a previously determined partial area of an entire area on the display 121.

According to an exemplary embodiment, the device 100 may display subtitle information on the display 121 simultaneously with output of sound with respect to the window selected to output the sound by the user from among the plurality of windows. That is, the window selected by the user may be reproducing content of high interest to the user, and thus, the device 100 may simultaneously provide sound information and the subtitle information.

The controller 130 of the device 100 may preset a location on which the subtitle is to be displayed among the entire area in correspondence with the selected window, according to an exemplary embodiment.

For example, the device 100 may display the subtitle of the content that is being reproduced in the window selected by the user in a partial area of the selected window or an external area thereof. The device 100 may provide subtitle information to an area such that the subtitle information provided therein has high readability, thereby providing the user with a more convenient viewing environment.

Referring to FIG. 5, the device 100 may display subtitle information of content that is being reproduced in a first window w21 that is selected to output sound by the user on an external area t21 of the first window w21. That is, the device 100 may display the subtitle information in an area that does not hide an image of the content that is being reproduced in the first window w21, thereby providing the subtitle information while not hiding the image of the content of high interest to the user.

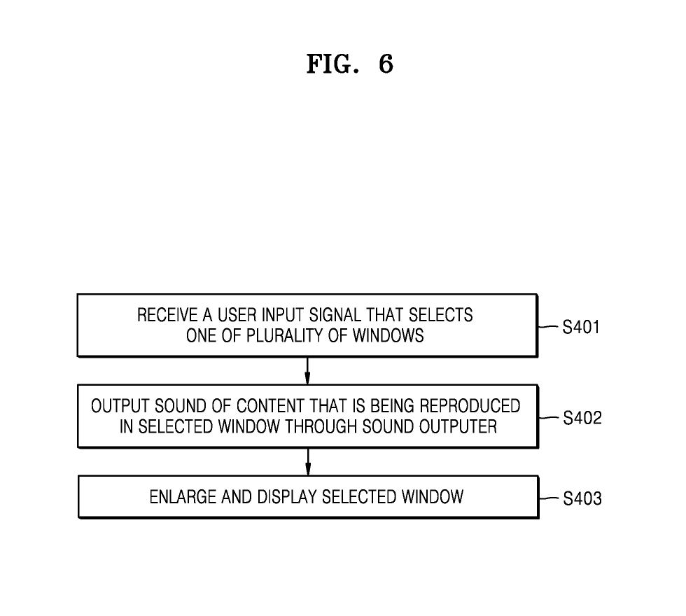

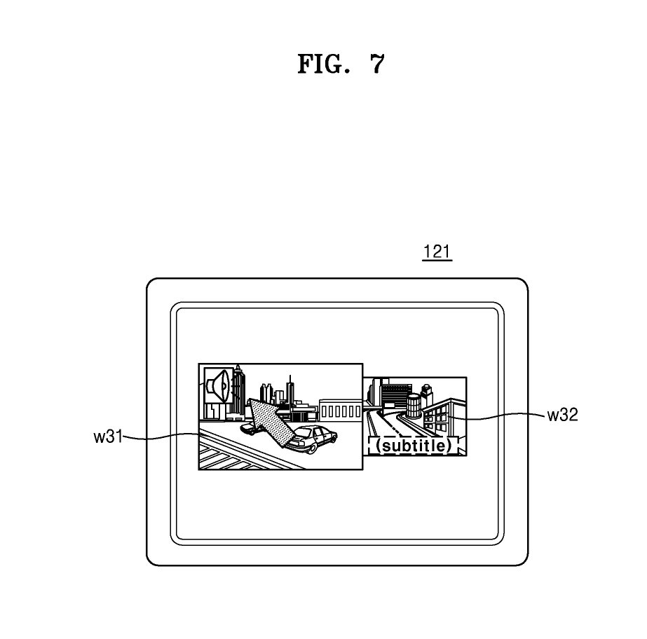

FIG. 6 is a flowchart illustrating enlarging and displaying a window selected by a user according to an exemplary embodiment. FIG. 7 is a view illustrating enlarging and displaying a window selected by a user according to an exemplary embodiment.

In operation S401 of FIG. 6, the controller 130 of the device 100 may receive a user input signal that selects one of a plurality of windows through the user inputter 110.

In operation S402, the controller 130 of the device 100 may output sound of the content that is being reproduced in the selected window through the sound outputter 122.

In operation S403, the controller 130 of the device 100 may enlarge the selected window and display the enlarged, selected window.

According to an exemplary embodiment, the controller 130 of the device 100 may enlarge the size of the selected window and display the enlarged window that is selected to output the sound of the content among the plurality of displayed windows. That is, the device 100 may enlarge the size of the window such that content of high interest to the user is reproduced in the window with high readability in comparison to the other windows.

FIG. 7 is a view illustrating enlarging the size of the first window w31 and displaying the enlarged first window w31 and reducing the size of a second window w32 and displaying the reduced second window w32 when sound of content that is being reproduced in the first window w31 is selected for output, according to an exemplary embodiment.

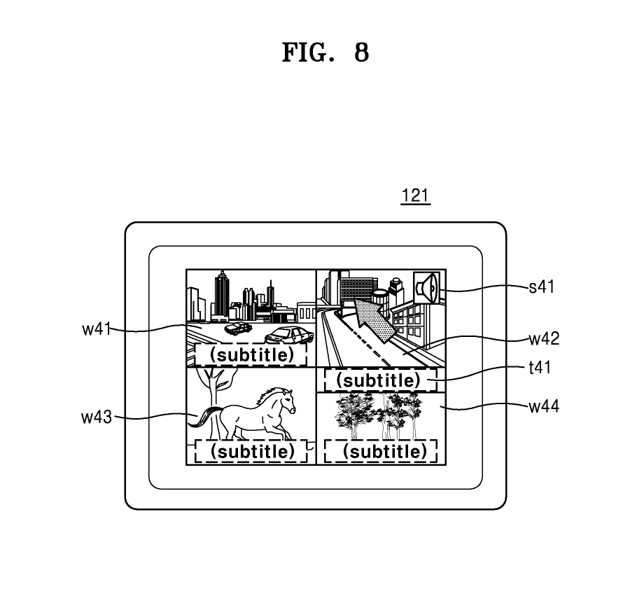

FIG. 8 is a view illustrating displaying subtitle of content that is being reproduced in a selected window according to an exemplary embodiment.

Referring to FIG. 8, when a second window w42 is selected from a plurality of windows w41, w42, w43, and w44, the device 100 may display subtitle information in an external area t41 of the second window w41 simultaneously with output s41 of sound of content that is being reproduced in the second window w42. The device 100 may display the subtitle information corresponding to the second window w42 in the external area t41 of the second window w41, thereby increasing readability for the user with respect to the subtitle while not hiding an image of the content that is being reproduced in the second window w42.

Accordingly, in an exemplary embodiment, a size of the fourth window w44 may be reduced.

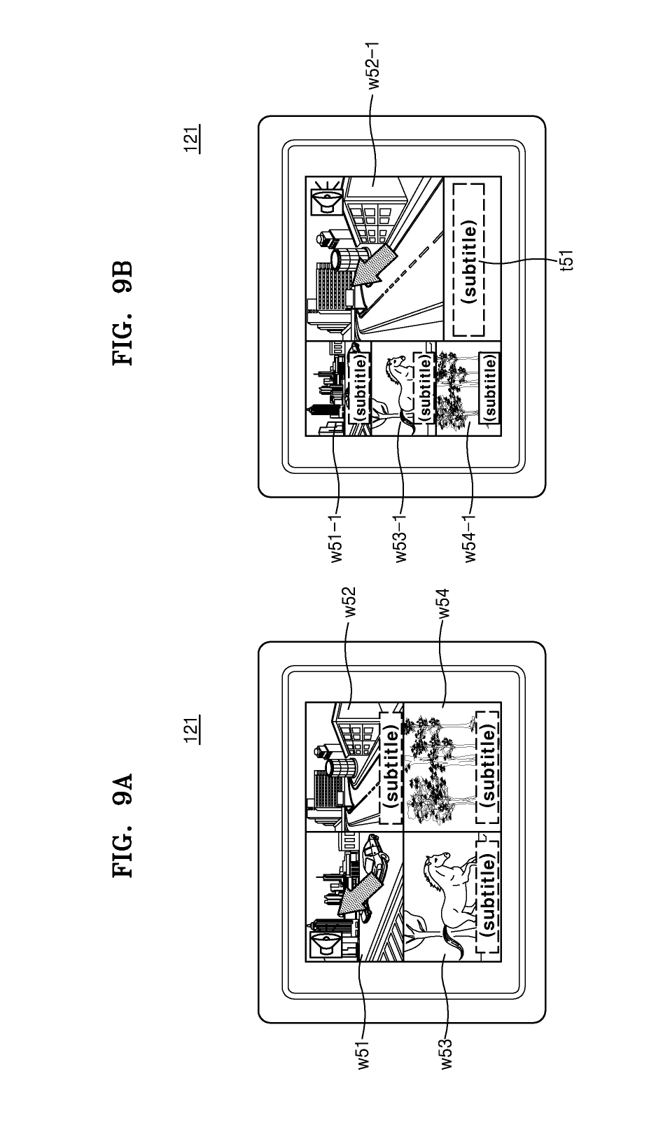

FIGS. 9A and 9B are views illustrating enlarging and displaying a selected window according to an exemplary embodiment.

FIG. 9A is a view illustrating selecting a first window w51 to output sound in the first window w51 among a plurality of displayed windows w51, w52, w53, and w54 according to an exemplary embodiment.

FIG. 9B is a view illustrating selecting the second window w52-1 to output sound in the second window w52-1 among the plurality of displayed windows w51-1, w52-1, w53-1, and w54-1 according to an exemplary embodiment. The device 100 may stop outputting the sound in the first window w51-1 and may output the sound of content that is being reproduced in the second window w52-1 through the sound outputter 122.

The device 100 may enlarge a second window w52-1 and display the enlarged second window w52-1 and may also reduce and rearrange other windows w51-1, w53-1, and w54-1 in a left area of the display 121, according to an exemplary embodiment.

The device 100 may display subtitle information of content that is being reproduced in the second window w52-1 in an external area t51 of the second window w52-1.

That is, the device 100 according to an exemplary embodiment may enlarge and display a window selected by a user and display subtitle information not to overlap with content, thereby increasing readability of content in which the user is interested in.

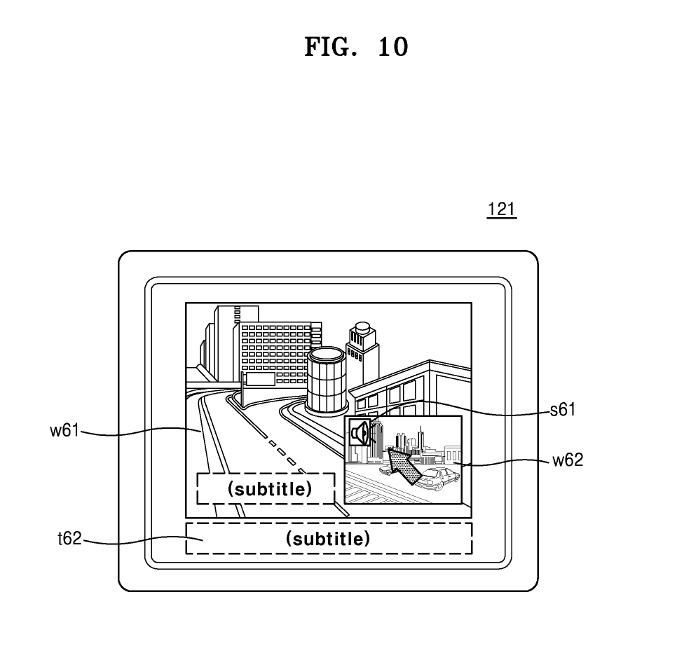

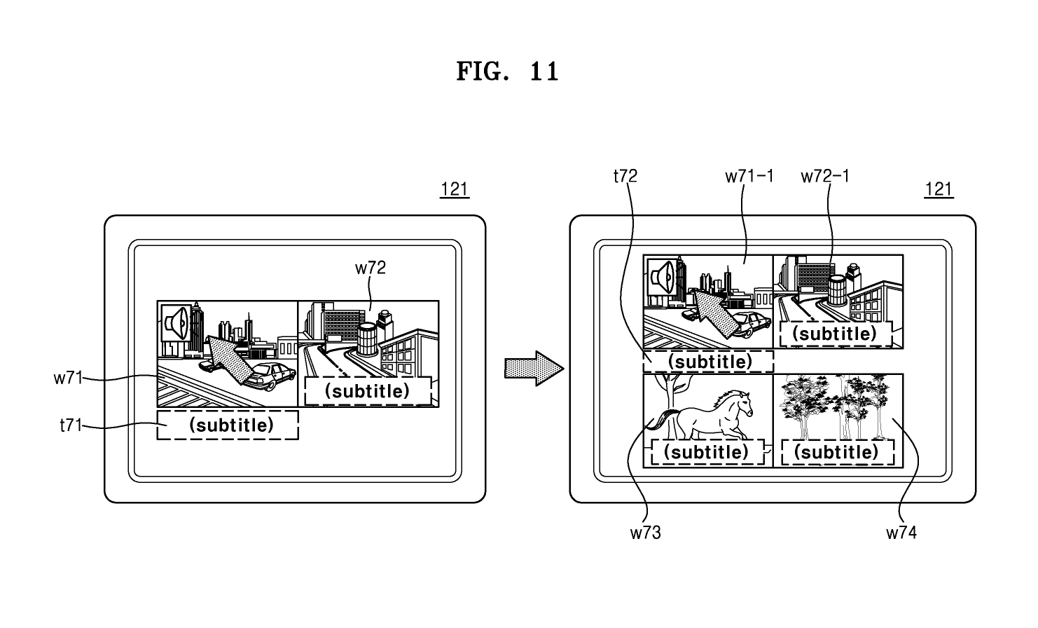

FIG. 10 is a view illustrating displaying a main window w61 and a sub-window w62 according to an exemplary embodiment.

The device 100 according to an exemplary embodiment may provide a picture in picture (PIP) function or functionality. The PIP function or functionality means a function of simultaneously displaying a small screen, separately from a main screen, on or inside the main screen.

Referring to FIG. 10, the controller 130 of the device 100 according to an exemplary embodiment may set one of a plurality of windows as the sub-window w62 and one of the windows that is distinguished from the sub-window w62 as the main window w61, and may overlap and display the sub-window w62 inside the main window w61.

If the controller 130 of the device 100 receives a user input signal that selects the sub-window w62, the controller 130 of the device 100 may display subtitle of content that is being reproduced in the sub-window w62 in a previously determined partial area of an entire area on the display 121.

That is, the device 100 may display subtitle information of the content that is being reproduced in the sub-window w62 in an external area t62 of the windows w61 and w62 in order to increase readability for a user.

FIG. 11 is a flow diagram illustrating changing a number of windows being displayed according to an exemplary embodiment.

As shown in FIG. 11, the controller 130 of the device 100 may change the number of the plurality of windows being displayed on the display 121. In FIG. 11, the view on the left illustrates an example of displaying two windows on the display 121. In FIG. 11, the view on the right illustrates a switch to displaying four windows on the display 121.

In FIG. 11, the view on the left illustrates displaying subtitle information of content that is being reproduced in a first window w71 on an external area t71 of the first window w71 when the first window w71 is selected to output sound.

In FIG. 11, the view on the right illustrates the number of the windows being increased to four. The controller 130 of the device 100 may continuously output sound information of content that is being reproduced in a first window w71-1 that is selected to output sound through the sound outputter 122.

The controller 130 of the device 100 may display subtitle information corresponding to the first window w71-1 in an external area t72 of the first window w71-1 such that an image displayed in the first window w71-1 is not hidden or partially obstructed by the subtitles. In an exemplary embodiment, the user may specify or preconfigure location for subtitles or the location for the subtitles may be selected by the controller based on factors such as a size of display, number of windows selected for the display, availability of a scroll function for a display such that some windows appear only when the scroll function is executed, and user preferences. Also, a size of subtitles may be pre-configured or automatically determined by the controller based on factors such as a size of display, number of windows selected for the display, availability of a scroll function for a display, amount of text to output, and type of the device.

As shown in FIG. 11, in the view on the right, subtitle information may be displayed in a preset area corresponding to each of windows w72-1, w73, and w74, except for the first window w71-1. That is, when the number of windows is increased, information of content reproduced in a newly added window may be provided through subtitle information displayed in an area corresponding to each window.

If the controller 130 of the device 100 receives a user input signal that selects the newly added window, the controller 130 of the device 100 may discontinue outputting sound corresponding to content being reproduced by a window and may output, through the sound outputter 122, sound information corresponding to content being reproduced in the selected window.

The aforementioned exemplary embodiments should be considered in a descriptive sense only and not for purposes of limitation, and are not limited to an order of the operations in the flowcharts of FIGS. 2 through 4. According to other exemplary embodiments, some operations may be skipped or added, and an order of some operations may be changed.

FIGS. 12 and 13 are block diagrams illustrating a device according to exemplary embodiments.

As illustrated in FIG. 12, the device 100 according to an exemplary embodiment may include the display 121, the sound outputter 122, a communicator 150, and the controller 130. However, not all elements shown in FIG. 12 are necessary elements of the device 100. That is, the device 100 may be embodied with more or less elements than the elements shown in FIG. 12, according to an exemplary embodiment.

For example, as illustrated in FIG. 13, the device 100 may further include a user inputter 110, an outputter 120, a sensor component 140, an audio/video (A/V) input interface 160, and a memory 170, in addition to the display 121, the sound outputter 122, the communicator 150, and the controller 130.

Hereinafter, the elements will be sequentially described.

The user inputter 110 may be a component by which a user inputs data so as to control the device 100. For example, the user inputter 110 may include a key pad, a dome switch, a touch pad (a touch capacitive type touch pad, a pressure resistive type touch pad, an infrared beam sensing type touch pad, a surface acoustic wave type touch pad, an integral strain gauge type touch pad, a piezo effect type touch pad, or the like), a jog wheel, and a jog switch, but one or more exemplary embodiments are not limited thereto but is provided by way of an example only.

The user inputter 110 may include an external device that may transmit a control signal via wired/wireless communication through the communicator 150. For example, the user inputter 110 may be a mouse, a keyboard, a remote controller, etc.

The user inputter 110 may receive a user input by being controlled by the controller 130. For example, the user inputter 110 may receive the user input that selects one of a plurality of windows displayed on the display 121.

The outputter 120 may output an audio signal, a video signal, or a vibration signal by being controlled by the controller 130, and may include the display 121, the sound outputter 122, a vibration motor 123, or the like.

The display 121 displays information that is processed in the device 100, by being controlled by the controller 130.

The display 121 according to an exemplary embodiment may include a plurality of windows configuring a multi-window environment. The display 121 may change the number of the plurality of windows and display the windows.

The display 121 may enlarge or reduce and display the windows, by being controlled by the controller 130. The display 121 may rearrange and display the plurality of windows, by being controlled by the controller 130. According to an exemplary embodiment, the controller 130 may control the display 121 to display the selected window in a predetermined area of the screen such that the window for which the sound is output is displayed in the same location of the screen. That is, in an exemplary embodiment, the windows may switch places or locations based on which window is selected by the user for sound output.

The display 121 may display subtitle information of content, under the control of the controller 130. The display 121 may display the subtitle information of the content in a window. The display 121 may display the subtitle information of the content in an external area of the display outside the window.

The display 121 may overlap and display one window in another window, under the control of the controller 130.

Meanwhile, when the display 121 and a touch pad form a mutual layer structure and then are formed as a touch screen, the display 121 may be used as both an output device and input device. The display 121 may include at least one of liquid crystal display (LCD), a thin film transistor-liquid crystal display (TFT-LCD), an organic light-emitting diode (OLED) display, a flexible display, a three-dimensional (3D) display, and an electrophoretic display. Also, according to a type of the device 100, the device 100 may include at least two displays 121. In this regard, the at least two displays 121 may be positioned to face each other by using a hinge.

The sound outputter 122 may output audio data that is received from the communicator 150 or is stored in the memory 170. The sound outputter 122 may also output a sound signal (e.g., a call signal receiving sound, a message receiving sound, a notifying sound, or the like) related to capabilities performed by the device 100. The sound outputter 122 may include a speaker, a buzzer, or the like.

The sound outputter 122 according to an exemplary embodiment may output sound information of content (for example, a moving image) that is being reproduced. For example, the sound outputter 122 may output sound information of content that is being reproduced in a window selected by a user through the user inputter 110 among the plurality of windows displayed on the display 121, under the control of the controller 130.

The vibration motor 123 may output a vibration signal. For example, the vibration motor 123 may output the vibration signal that corresponds to an output of the audio data (e.g., the call signal receiving sound, the message receiving sound, or the like) or video data. Also, when a touch is input to the touch screen, the vibration motor 123 may output a vibration signal.

The controller 130 may generally control all operations of the device 100. For example, the controller 130 may control the user inputter 110, the outputter 120, the sensor component 140, the communicator 150, the A/V input interface 160, etc. by executing programs stored in the memory 170.

In more detail, the controller 130, according to an exemplary embodiment, may receive a user input signal that selects one of the plurality of windows displayed on the display 121 through the user inputter 110.

The controller 130 may output the sound of the content that is being reproduced in the selected window through the sound outputter 122.

The controller 130 may stop outputting sound of content that are being reproduced in the windows among the plurality of windows, except for the selected window.

The controller 130 may display subtitle information of the content that are being reproduced in the windows among the plurality of windows, except for the selected window, in an area of the display 121 corresponding to each window based on the user input signal that selects one of the plurality of windows displayed on the display 121 through the user inputter 110.

The controller 130 may display subtitle of the content that is being reproduced in the selected window such that the subtitle may not overlap with an image of the content that is being reproduced in the selected window based on the user input signal that selects one of the plurality of windows displayed in the display 121 through the user inputter 110.

When the controller 130 receives the user input signal that selects one of the plurality of windows displayed on the display 121 through the user inputter 110, the controller 130 may enlarge and display the selected window in an enlarged size.

When the controller 130 receives the user input signal that selects one of the plurality of windows displayed on the display 121 through the user inputter 110, the controller 130 may rearrange and display the windows among the plurality of windows except for the selected window.

The controller 130 may set one of the plurality of windows displayed on the display 121 as a sub-window and set one of the plurality of windows that is distinguished from the sub-window as a main window. The controller 130 may overlap and display the sub-window on the main window.

If the controller 130 receives a user input signal that selects the sub-window through the user inputter 110, the controller 130 may display subtitle of content that is being reproduced in the sub-window on a previously determined partial area of an entire are of the display 121. The sensor component 140 may sense a state of the device 100 or a status of the device 100, or an environment of the device 100, and may transfer sensed information to the controller 130. The sensor component 140 may include at least one selected from a magnetic sensor 141, an acceleration sensor 142, a temperature/humidity sensor 143, an infrared sensor 144, a gyroscope sensor 145, the location sensor (e.g., GPS) 146, an air pressure sensor 147, a proximity sensor 148, and an RGB sensor (i.e., a luminance sensor) 149, but one or more exemplary embodiments are not limited thereto. Functions of the sensors may be intuitionally deduced by one of ordinary skill in the art by referring to names of the sensors, and thus, detailed descriptions thereof are omitted here.

The sensor component 140 may include a sensor for sensing a touch input via an input instrument, and a sensor for sensing a touch input by a user. In this case, the sensor for sensing the touch input by the user may be included in the touch screen or the touch pad. Also, the sensor for sensing the touch input via the input instrument may be formed below or in the touch screen or the touch pad.

The communicator 150 may include one or more elements allowing communication between the device 100 and an external device or between the device 100 and a server (not shown). For example, the communicator 150 may include a short-range wireless communicator 1510, a mobile communicator 152, and a broadcast receiver 153.

The short-range wireless communicator 1510 may include, but is not limited to, a Bluetooth communicator, a BLE communicator, an NFC, a WLAN (Wi-Fi) communicator, a ZigBee communicator, an infrared Data Association (IrDA) communicator, a Wi-Fi Direct (WFD) communicator, an ultra wideband (UWB) communicator, or an Ant₊ communicator.

The mobile communicator 152 exchanges a wireless signal with at least one of a base station, an external terminal, and a server on a mobile communication network. The wireless signal may include various types of data according to communication of a sound call signal, a video call signal, or a text/multimedia message.

The broadcast receiver 153 receives a broadcast signal and/or information related to a broadcast from the outside through a broadcast channel. The broadcast channel may include a satellite channel and a ground wave channel. In another exemplary embodiment, the device 100 may not include the broadcast receiver 153.

The A//V input interface 160 may receive an input of an audio signal or a video signal and may include a camera 161 and a microphone 162. The camera 161 may obtain an image frame such as a still image or a moving picture via an image sensor during a video call mode or an image-capturing mode. An image that is captured via the image sensor may be processed by the controller 130 or a separate image processing unit (not shown).

The image frame that is processed by the camera 161 may be stored in the memory 170 or may be transmitted to an external source via the communicator 150. According to a configuration of the device 100, two or more cameras 161 may be arranged, according to an exemplary embodiment.

The microphone 162 receives an input of an external sound signal and processes the received sound signal into electrical voice data. For example, the microphone 162 may receive a sound signal from an external device or a speaker. In order to remove noise that occurs while the sound signal is externally input, the microphone 162 may use various noise removing algorithms.

The memory 170 may store a program for processing and controlling the controller 130, and may store a plurality of pieces of data that are input to or output from the device 100.

The memory 170 may include a storage medium of at least one type selected from a flash memory, a hard disk, a multimedia card type memory, a card type memory such as a secure digital (SD) or xD-Picture (xD) card memory, a random access memory (RAM), a static random access memory (SRAM), a read-only memory (ROM), an electrically erasable programmable read-only memory (EEPROM), a programmable read-only memory (PROM), a magnetic memory, a magnetic disc, and an optical disc. Also, the device 100 may run web storage or a cloud server that performs a storage function of the memory 170 on the Internet.

Programs stored in the memory 170 may be classified into a plurality of modules according to their functions, for example, into a user interface (UI) module 171, a touch screen module 172, an alarm module 173, etc.

The UI module 171 may provide a specialized UI or graphical user interface (GUI) in connection with the device 100 for each application. The touch screen module 172 may detect a user's touch gesture on the touch screen and transmit information related to the touch gesture to the control unit 130. The touch screen module 172 may recognize and analyze a touch code. The touch screen module 172 may be configured by additional hardware including a controller.

Various sensors may be arranged in or near the touch screen so as to detect a touch or a proximate touch on the touch sensor. An example of the sensor to detect the touch on the touch screen may include a tactile sensor. The tactile sensor detects a contact of a specific object at least as sensitively as a person can detect. The tactile sensor may detect various types of information such as the roughness of a contact surface, the hardness of the contact object, the temperature of a contact point, or the like.

An example of the sensor to detect the touch on the touch screen may include a proximity sensor. The proximity sensor detects the existence of an object that approaches a predetermined detection surface or that exists nearby, by using a force of an electro-magnetic field or an infrared ray, instead of a mechanical contact. Examples of the proximity sensor include a transmission-type photoelectric sensor, a direction reflection-type photoelectric sensor, a mirror reflection-type photoelectric sensor, a high frequency oscillation-type proximity sensor, a capacity-type proximity sensor, a magnetic proximity sensor, an infrared-type proximity sensor, or the like. The touch gesture of the user may include a tap gesture, a touch & hold gesture, a double tap gesture, a drag gesture, a panning gesture, a flick gesture, a drag & drop gesture, a swipe gesture, or the like.

The alarm module 173 may generate a signal for notifying the user about an occurrence of an event in the device 100. Examples of the event that may occur in the device 100 include a call signal receiving event, a message receiving event, a key signal input event, a schedule notifying event, or the like. The alarm module 173 may output an alarm signal in the form of a video signal via the display unit 121, an alarm signal in the form of an audio signal via the sound outputter 122, or an alarm signal in the form of a vibration signal via the vibration motor 123.

The one or more exemplary embodiments may be embodied as a recording medium, e.g., a program module to be executed in computers, which include computer-readable commands. The computer storage medium may include any usable medium that may be accessed by computers, volatile and non-volatile medium, and detachable and non-detachable medium. Also, the computer storage medium includes all volatile and non-volatile media, and detachable and non-detachable media which are technically implemented to store information including computer readable commands, data structures, program modules or other data. The communication medium includes computer-readable commands, a data structure, a program module, other data as modulation-type data signals such as carrier signals, or other transmission mechanism, and includes other information transmission mediums.

Throughout the specification, various components may indicate a hardware component such as a processor or a circuit, and/or may indicate a software component that is executed by a hardware configuration such as a processor.

It should be understood that exemplary embodiments described herein should be considered in a descriptive sense only and not for purposes of limitation. Descriptions of features or aspects within each exemplary embodiment should typically be considered as available for other similar features or aspects in other exemplary embodiments. For example, configuring elements that are singular forms may be executed in a distributed fashion, and also, configuring elements that are distributed may be combined and then executed.

While one or more exemplary embodiments have been described with reference to the figures, it will be understood by those of ordinary skill in the art that various changes in form and details may be made therein without departing from the spirit and scope as defined by the following claims and their equivalents.

1. A device comprising:
a sound outputter configured to output sound of content;
a display configured to display a plurality of windows; and
a controller configured to, in response to receiving a selection of one of the plurality of windows, outputting the sound of the content being reproduced in the selected window through the sound outputter,
wherein the controller is further configured to control the display to display subtitles of the content being reproduced in the selected window, on a determined portion of an entire area of the display, based on a user input signal.

2. The device of claim 1, wherein, in response to the receiving the selection of said one of the plurality of windows, the controller is further configured to discontinue outputting sound of contents being reproduced in the plurality of windows, except for the sound of contents in selected window, and
wherein, based on the receiving the selection, the controller is configured to control the display to display subtitles of the content being reproduced in the plurality of windows except for the selected window.

3. (canceled)

4. The device of claim 1, wherein the controller is further configured to control the display to display subtitles of the content being reproduced in the selected window such that the displayed subtitles do not overlap with an image of the content being reproduced in the selected window, based on a user input signal.

5. The device of claim 1, wherein the controller is configured to enlarge the selected window in response to the receiving of a user input signal and control the display to display the enlarged selected window.

6. The device of claim 5, wherein the controller is configured to rearrange the windows among the plurality of windows except for the selected window, in response to the receiving of the user input signal.

7. The device of claim 1, wherein the controller is configured to discontinue outputting the sound of the content being reproduced in the selected window and outputting sound of content being reproduced in another window in response to receiving a selection signal for the other window,
wherein the other window and the selected window are different.

8. The device of claim 1, wherein the controller is configured to set a first window of the plurality of windows as a sub-window, and is configured to set a second window of the plurality of windows, as a main window, and displays the sub-window in the main window,
wherein the sub-window overlaps the main window.

9. The device of claim 8, wherein the controller is configured to control the display to display subtitles of content being reproduced in the sub-window on a previously determined portion of an entire area of the display in response to receiving a selection of the sub-window.

10. A method comprising:
displaying a plurality of windows on a display;
receiving a selection signal selecting one of the displayed plurality of windows;
outputting, through a sound outputter, sound of content being reproduced in the displayed selected window; and
displaying subtitles of the content being reproduced in the selected window, on a determined portion of an entire area of the display, based on user input.

11. The method of claim 10, further comprising:
discontinuing outputting sound of content being reproduced in the displayed plurality of windows except for the selected displayed window; and
displaying subtitles of the content being reproduced in the plurality of windows except for the selected window, in areas of the display corresponding to the plurality of windows, based on user input.

12. (canceled)

13. The method of claim 10, further comprising:
displaying subtitles of the content being reproduced in the selected window such that the displayed subtitles do not overlap with an image of the content being reproduced in the selected window, based on user input.

14. The method of claim 10, further comprising:
receiving user input;
enlarging the selected window in response to the receiving user input; and
displayed the enlarged selected window.

15. The method of claim 14, wherein the enlarging and the displaying comprises rearranging the windows among the plurality of windows except for the selected window.

16. The method of claim 10, further comprising:
receiving user input indicating a selection of another window from the displayed plurality of windows, wherein the selected window is a first window and said another window is a second window, and wherein the first window and the second window are different areas of the display; and
in response to the receiving of user input, discontinuing outputting the sound of the content being reproduced in the first window and outputting sound of content being reproduced in the second window.

17. The method of claim 10, wherein the displaying of the plurality of windows comprises:
setting a first window of the plurality of windows as a sub-window;
setting a second window of the plurality of windows as a main window, wherein the first window and the second window are different; and
displaying the sub-window on the displayed main window,
wherein the sub-window overlaps the main window.

18. The method of claim 17, further comprising:
receiving user input indicating a selection of the sub-window; and
displaying subtitles of content being reproduced in the sub-window in a determined portion of an entire area of the display in response to the received user input.

19. The method of claim 10, further comprising:
receiving user input indicating a selection of another window of the displayed plurality of windows;
discontinuing outputting the sound of the content being reproduced in the displayed selected window and outputting sound of content being reproduced in said another window, in response to the receiving of the user input; and
switching at least one of size and location of the selected window with said another window, in response to the receiving of the user input.

20. The method of claim 19, further comprising:
in response to the receiving the user input, changing a location of an element indicating sound output from the selected window to said another window.
